(19) United States
(12) Patent Application Publication
(10) Pub. No.: US 2019/0308652 A1
(43) Pub. Date: Oct. 10, 2019

(54) CART COLLISION AVOIDANCE SYSTEM

(71) Applicant: Walmart Apollo, LLC, Bentonville, AR (US)

(72) Inventors: Bruce Green, Centerton, AR (US); Yurgis Mauro Bacallao, Centerton, AR (US); Omar Cerda, Centerton, AR (US); Michael D. Bookman, Suwanee, GA (US)

(21) Appl. No.: 16/364,915

(22) Filed: Mar. 26, 2019

Related U.S. Application Data
(60) Provisional application No. 62/653,992, filed on Apr. 6, 2018.

(51) Int. Cl. B62B 5/04; B60Q 1/26; B60Q 1/52; B60T 7/22; B60T 7/12; B60T 8/17

(52) U.S. Cl. CPC B62B 5/0404; B60Q 1/2607; B60T 8/1701; B60T 7/22; B60T 7/12; B60Q 1/525

(57) ABSTRACT

A shopping cart that avoids collisions during movement comprises a proximity detection system comprising one or more sensors that detect and recognize an object along the path of the shopping cart; a controller that determines from data collected by the one or more sensors whether a collision between the shopping cart and the object is possible; a feedback system that provides one or more of audible, visual, or tactile feedback to a user of the shopping cart when the controller determines that the collision is possible; and a braking system that automatically stops the shopping cart from continued motion when the controller determines that the collision is possible. At least one of the feedback system and the braking system is activated in response to the controller determining that the shopping cart is a predetermined distance from the object.

### RELATED APPLICATIONS

This application claims the benefit of U.S. Provisional Patent Application No. 62/653,992 filed Apr. 6, 2018 and entitled “Cart Collision Avoidance System,” the contents of which are incorporated by reference herein in their entirety.

### TECHNICAL FIELD

The present disclosure relates generally to a computer-based shopping cart, and in particular, to a system for a shopping cart that detects possible collisions, alerts a user of such collisions, and controls the shopping cart to prevent such collisions.

### BACKGROUND

Modern retail establishments strive to incorporate computer technology into various aspects of a shopper's experience while in the store. Some stores provide electric shopping carts, also referred to as “smart carts,” for their customers, which require the store customer users to operate the carts in a similar manner as an automobile, golf cart, or other operated machinery. The risk of collision between an electric shopping cart and other carts or other objects in a store is increased due to operator error, neglect, or distractions.

### SUMMARY

In one aspect, a shopping cart that avoids collisions during movement comprises a proximity detection system comprising one or more sensors that detect and recognize an object along the path of the shopping cart; a controller that determines from data collected by the one or more sensors whether a collision between the shopping cart and the object is possible; a feedback system that provides audible, visual (colors), and/or tactile feedback to a user of the shopping cart when the controller determines that the collision is possible; and a braking system that automatically stops the shopping cart from continued motion when the controller determines that the collision is possible, wherein at least one of the feedback system and the braking system is activated in response to the controller determining that the shopping cart is a predetermined distance from the object.

In another aspect, a cart collision avoidance system comprises a proximity detection system that detect s an object along the path of a shopping cart; a controller that determines from data collected by the proximity detection system whether a collision between the shopping cart and the object is possible; a feedback system that that notifies a user of the shopping cart in response to the proximity detection system detecting the object and provides one or more of audible, visual, or tactile feedback to a user of the shopping cart when the controller determines that the collision is possible; and a braking system that automatically stops the shopping cart from continued motion when the controller determines that the collision is possible, wherein at least one of the feedback system and the braking system is activated in response to the controller determining that the shopping cart is a predetermined distance from the object.

### BRIEF DESCRIPTION OF THE DRAWINGS

Exemplary embodiments will now be described, by way of example only, with reference to the following drawings, in which:

FIG. 1 is a perspective view of a shopping cart, in accordance with some embodiments.

FIG. 2 is a block diagram of a cart collision avoidance system, in accordance with some embodiments.

FIG. 3 is a network diagram illustrating an environment in which embodiments of the shopping cart of FIGS. 1 and 2 are practiced.

FIG. 4 is a block diagram illustrating the relationship between elements of the cart collision avoidance system when implemented in a shopping cart, in accordance with some embodiments.

FIGS. 5A- 5G collectively illustrate a flow diagram of a method of operation of a cart collision avoidance system, in accordance with some embodiments.

### DETAILED DESCRIPTION

A detailed description of the hereinafter described embodiments of the disclosed apparatus and method are presented herein by way of exemplification and not limitation with reference to the Figures. Although certain embodiments are shown and described in detail, various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

In brief overview, provided are embodiments of a system and method for providing audible, visual, and/or tactile feedback on a shopping cart to avoid collisions with other carts, moving objects, liquid spills, or other obstacles where a user of the cart cannot see such obstacles. In some embodiments, one or more sensor types of a shopping cart, for example, positioned at a front end or corners of the cart, are constructed and arranged to “peek” around the corners or aisles or other store locations along a path of the cart as the customer moving the cart approaches the corner, turn, bend, or other blind spot. In some embodiments, the sensors may detect an obstacle several feet before the user's eyes view the obstacle, but not limited thereto. A combination of visible lights such as light emitting diodes (LEDs), audible sounds, and tactile feedback from a vibrating handle may be used to warn the cart user of an impending collision.

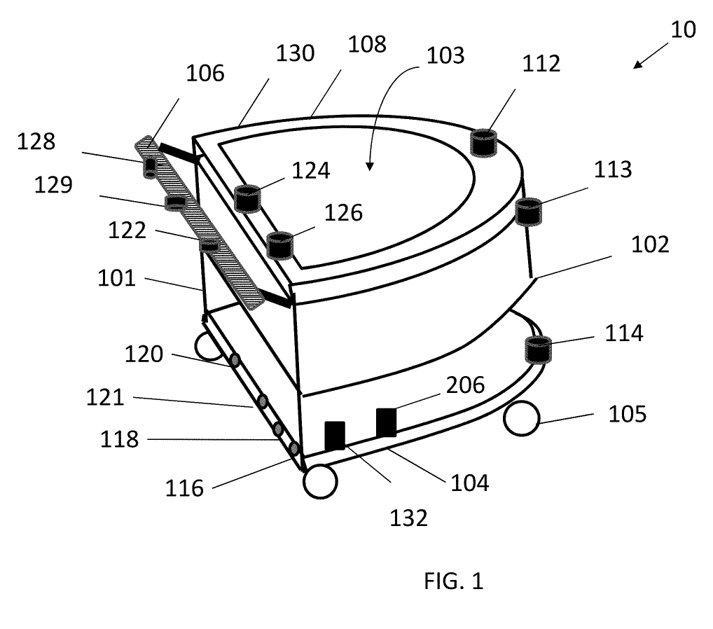

FIG. 1 is a perspective view of a shopping cart 10, in accordance with some embodiments. In particular, the cart 10 is a special-purpose cart in that the cart 10 is constructed and arranged so that a user can avoid possible collisions with other shopping carts or objects in a path in front of the cart 10 during movement.

To operate according to the foregoing, the shopping cart 10 is constructed and arranged to receive and hold items for purchase, and in doing so, is formed of well-known components such as a frame 101, at least one basket 102, base 104, wheels 105, and handle 106.

The basket 102 may be part of or otherwise coupled to a top region 108 of the base 104. In some embodiments, the base 104 includes a platform on which various items are positioned for transport, for example, in lieu of or in addition to the basket 102.

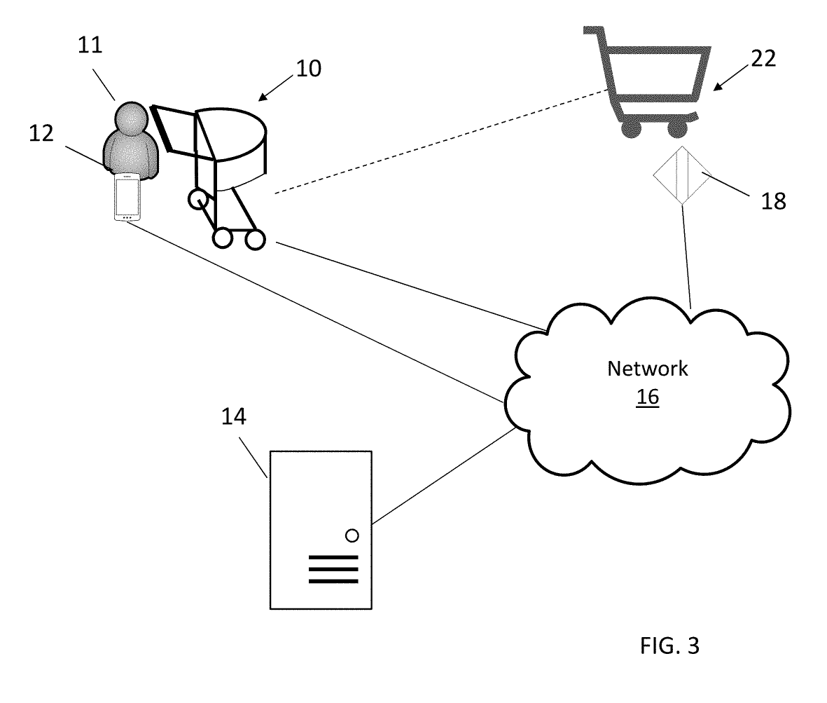

The frame 101, also referred to as a support structure, is constructed and arranged to support the basket(s) 102, base 104, wheel assembly 105, and handle 106. The basket 102 has an interior 103 configured to carry items of interest or need by a user such as a store customer 11 shown in FIG. 3 for transport to a checkout location for purchase. Some or all of the frame 101 may be formed of tubular or other elongated elements, for example, metal and/or plastic rod-shaped elements. The frame 101 may include a vertical portion that extends to the base portion 104.

The top region 108 may be positioned about at least a portion of the frame 101. A pressure plate sensor 130 may be at the top region 108. The pressure plate sensor 130 is constructed and arranged on the handle 106 and top of the cart to detect a force applied by a user's hand indicating that a force is being applied against the cart 10. In some embodiments, autolocking brakes engage automatically when a predetermined excessive speed, e.g., 5 mph, is reached and a determination is made by the pressure sensor 130 that no force is acted upon the cart 10. Other devices coupled to the top region 108 may include but not be limited to a plurality of light emitting elements 112, e.g., LEDs or the like, an audio device 124 such as a speaker, a microphone 126 or the like, and/or one or more sensor types such as a pressure plate sensor 130 described herein. The LEDs 112 are positioned on the cart 10 to emit various colors relevant to the understanding to a viewer such as an operator of the cart 10. For example, a green light may indicate a clear shopping route, a yellow light may alert a shopper of a possible collision ahead, and a red light may indicate that a collision has occurred.

The audio device 124 is configured to output audio which may include information that is useful to the listener. The microphone 126 is configured to receive and process sounds, such as commands or other information provided by a cart user or other person, and/or sounds output from an electronic device such as the user's smartphone 12 shown in FIG. 3.

In some embodiments, a cover, for example, a pressure plate cover, may partially or completely enclose some or all of these devices at the top region 108. In some embodiments, the cover may include translucent or transparent material for permitting colors emitted by the light emitting elements 112 to be viewed by a cart user or other observer.

The wheel assembly 105 has a set of wheels rotatably coupled to the base 104, which allows the cart 10 to roll along the ground on the set of wheels. In some embodiments, the wheels may be at regions of the base 104 or other bottommost region of the frame 101 for permitting a distribution of weight of items placed on the cart 10, for example, four wheels at the four corners of the base 104. In some embodiments, the wheels are similar to or the same as those used on a conventional shopping cart except that a braking system 206 described herein can communicate to lock or unlock the wheels with respect to a rotating motion of the wheels. In some embodiments, the wheels are removable for replacement with new wheels, or interchangeable with shopping cart wheels or related wheels. The wheels may be removable by including a locking mechanism (not shown) that attaches to an axle or other component of the wheel assembly 105, and that for removing the wheels 105 from the axle or other component of a wheel assembly. In some embodiments, the cart 10 may include shock absorbers, springs, and/or other suspension-related elements to dampen, absorb or otherwise reduce the shock impulses produced during motion of the cart 10.

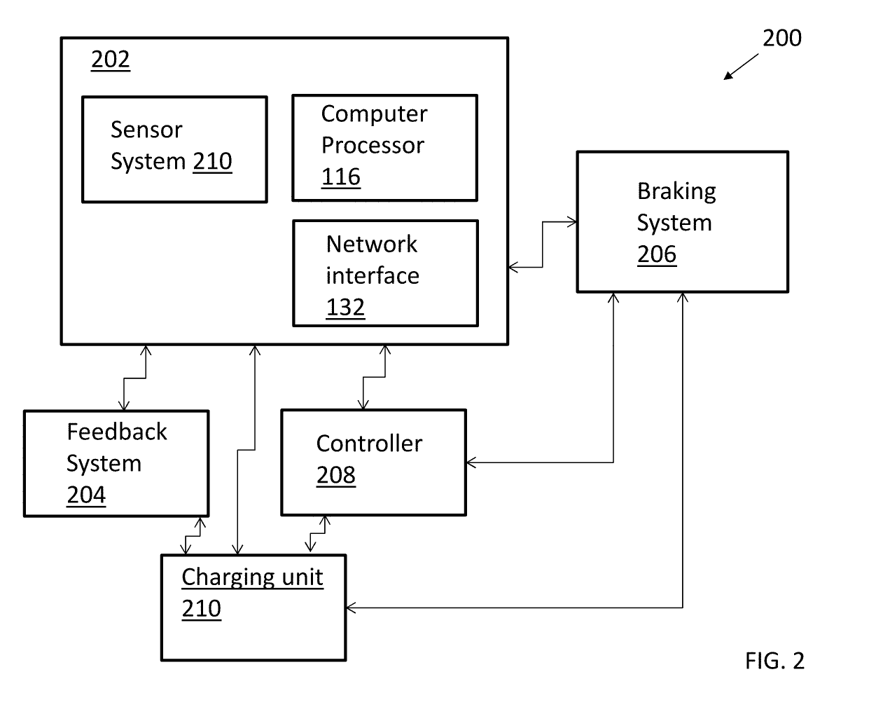

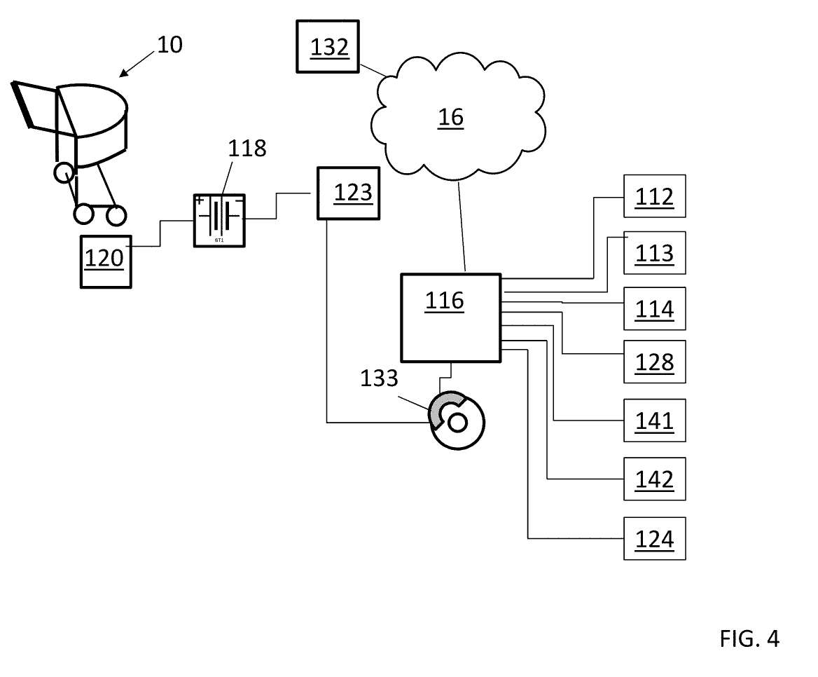

The braking system 206 of the wheel assembly 105 (see FIGS. 2 and 4) may automatically stop the shopping cart 10 from continued motion or otherwise prevents the wheels 105 from rotating when a possible collision is imminent or otherwise determined. For example, the braking system 206 includes a foot, shoe, pad, caliper, or other brake type that is activated by a cable assembly that applies a force against one or more of the wheels 105 to stop or reduce any rotation of the wheels 105 or otherwise prevents the free rotation of a wheel 105 about its axle. In some embodiments, the braking system 206 is controlled by an autobrake controller (described below). In response to a detection of a possible collision, the autobrake controller may automatically control the force of the shoe, pad, or the like applied to the wheel 105 by instructing the braking system 206 to apply the shoe, pad, or the like to one or more of the cart wheels 105 to prevent the wheels 105 from rotating. Similarly, the autobrake controller can generate control-related instructions to cause the braking system 206 to withdraw a force to allow the wheels 105 to rotate freely. IN some embodiments, the cart 10 includes an emergency mechanical braking device (not shown) on or near the handle 106, for example, a handle that when pulled activates the wheel locking mechanism 133.

In some embodiments, the handle 106 may be used by a shopper to push the cart 10. The handle 106 may be configured to integrate with one or more buttons, switches, computer processes, or the like for operating the cart 10 from the handle 106. For example, the handle 106 may include one or more switching devices 122 and one or more haptic feedback devices 128 such as vibrating tactile nodes or the like on the handle 106, one or more pressure sensors 129 (distinguished from pressure plate sensors 130), and/or other control devices.

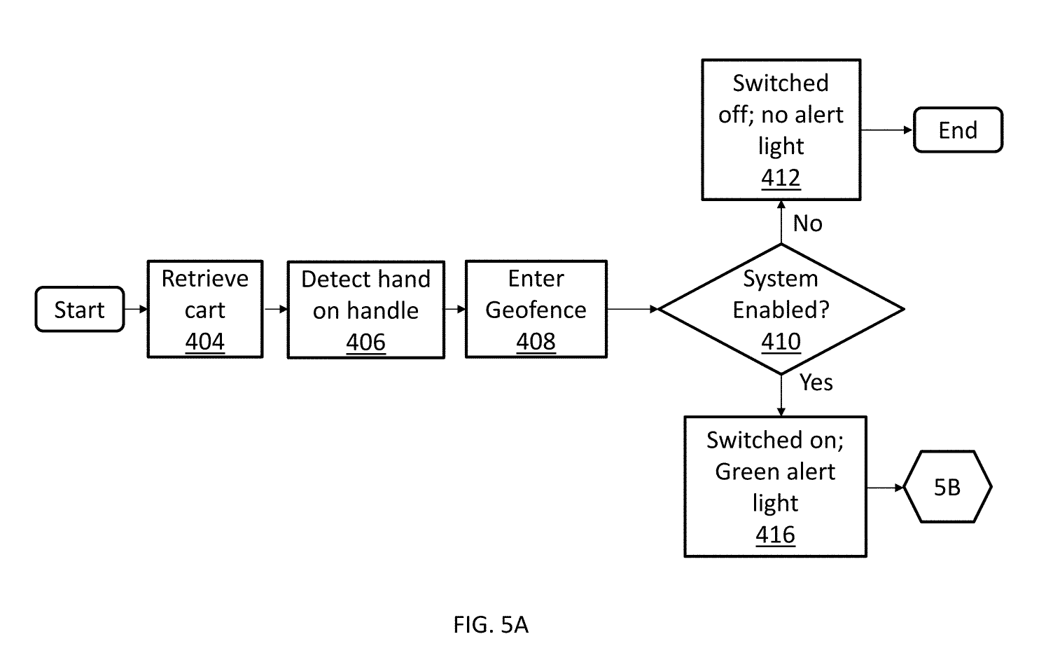

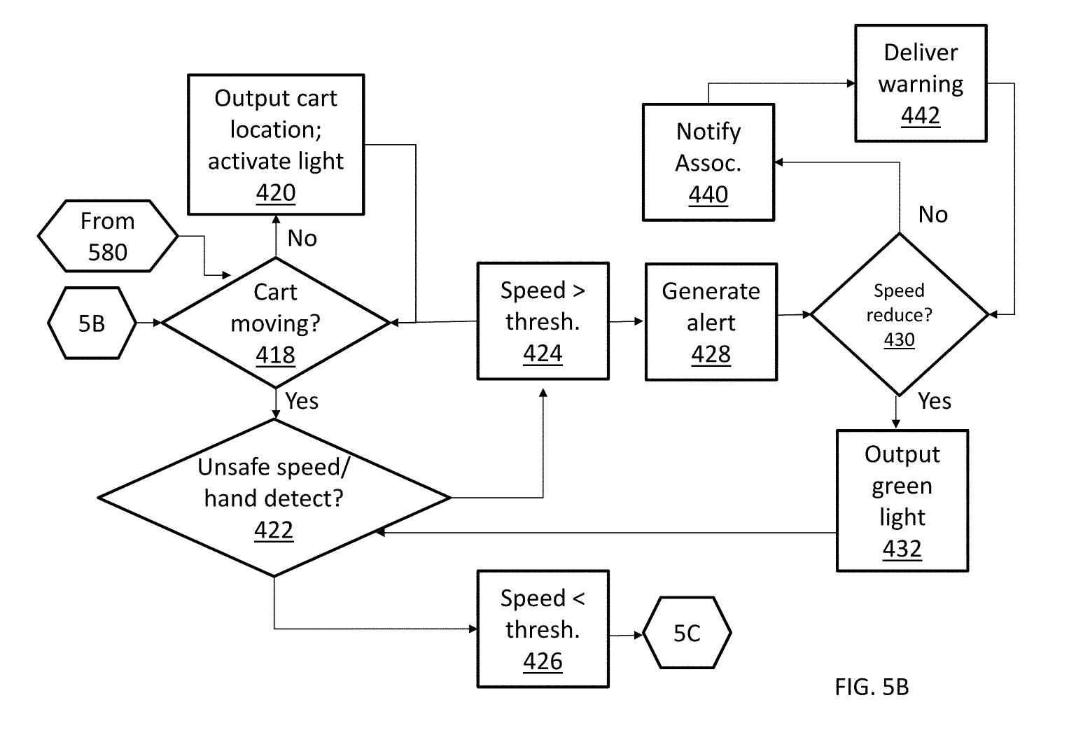

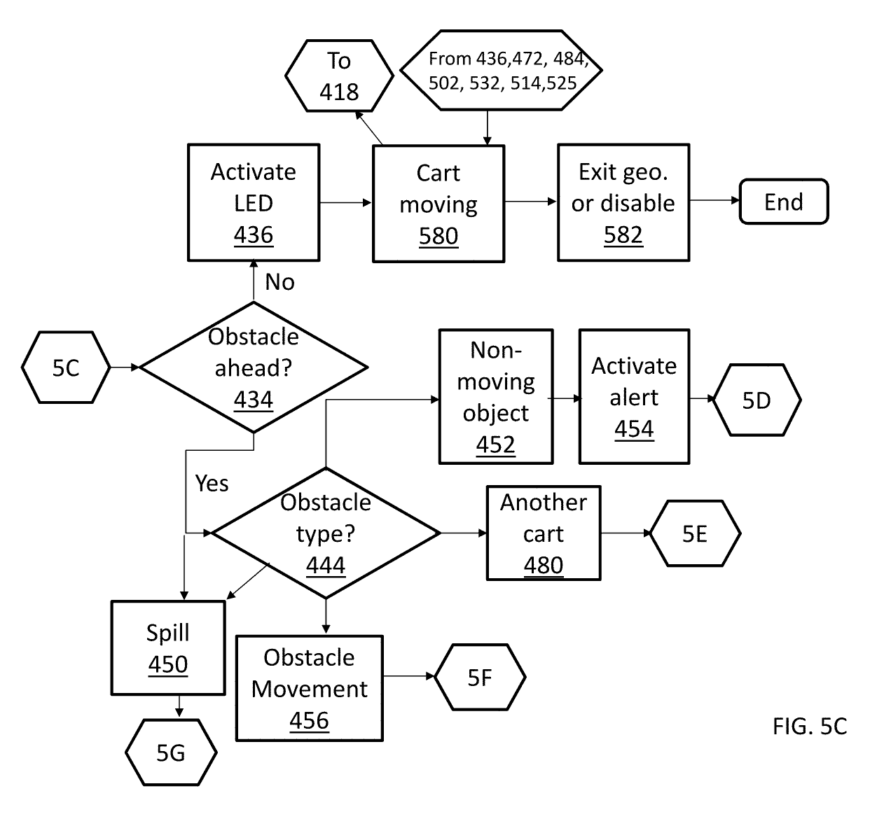

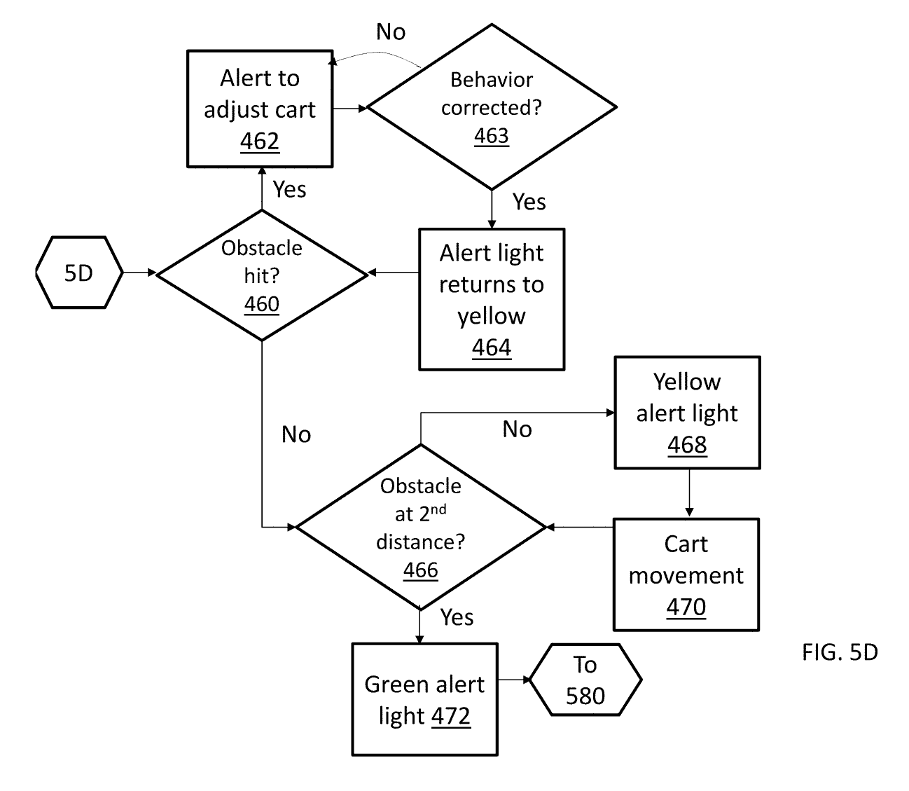

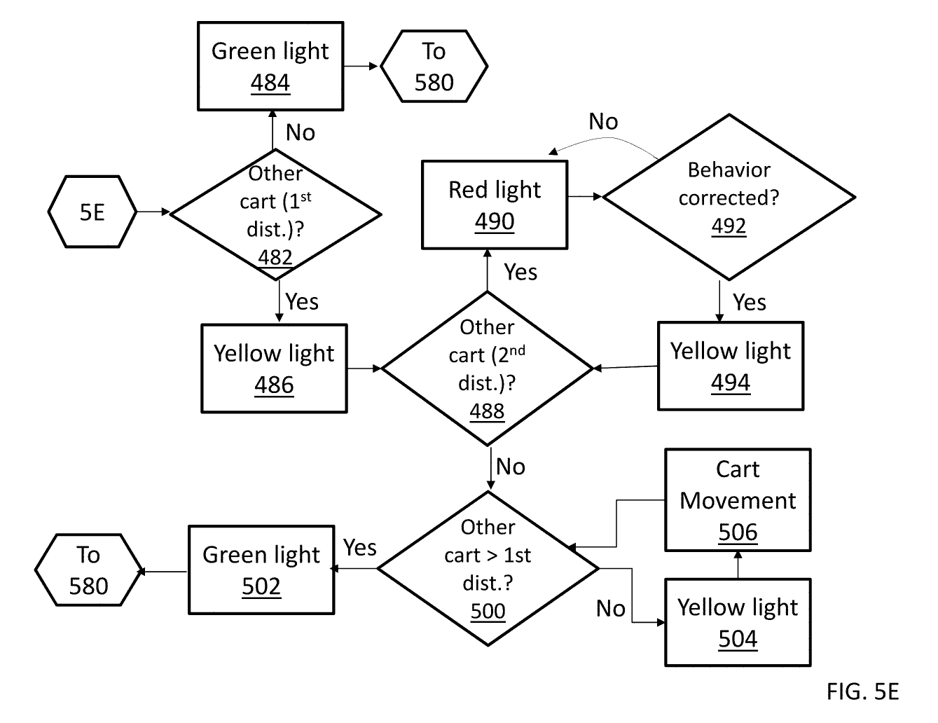

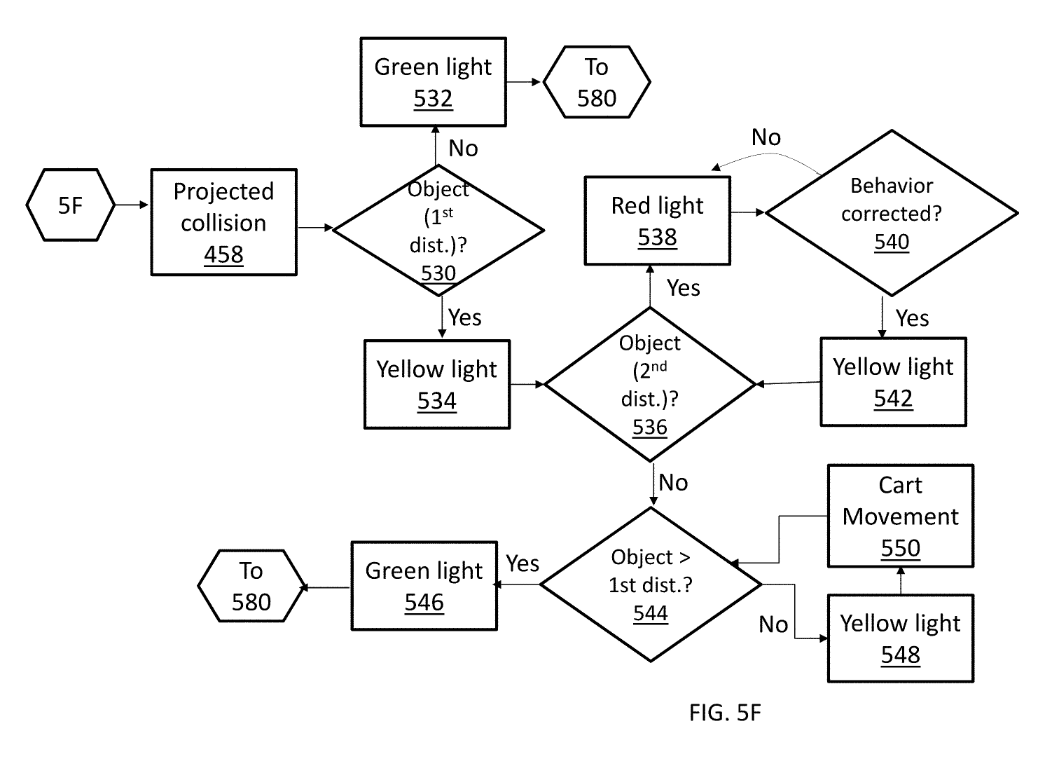

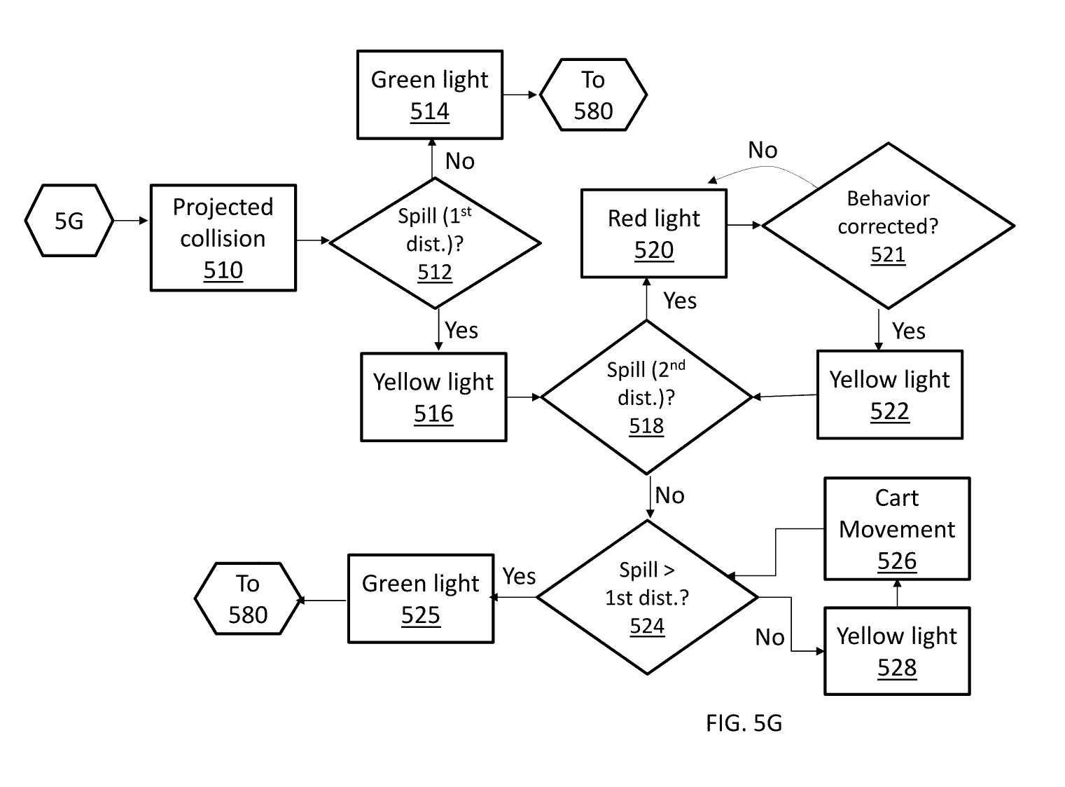

In some embodiments, one of the switches 122 is an on/off switch that turns some or all of the cart collision avoidance system 200 (see FIG. 2) on or off, for example, the sensor control system, autobrake, and/or related components can be activated or inactivated by the switch 122. In other embodiments, a software application executed at a smartphone or other computing device of the cart user can be used instead of the switches 122 to perform such operations by sending data commands via a wireless interface or other communication device of a network interface 132 integrated with or otherwise coupled to the cart 10. The network interface 132 provides a data path between external computers 14 via a data network 16 and one or more cart computers and electronic components such as light emitting elements 112, audio device 124, microphone 126, various sensors, switches, and control devices. In some embodiments, the network interface 132 includes global positioning (GPS), infrared (RFID), and/or WiFi devices for communicating with a virtual geographic boundary such as a geofence device, e.g., sensor 18 shown in FIG. 3 or the like. In doing so, the system may process signals exchanged between the network interface 132 and the network devices to establish a location of the cart and/or determine a color to be illuminated by an LED 112. An LED 112 can be configured to emit only a single color. Alternatively, an LED 112 can emit different colors depending on a state, for example, according to a received signal from a CPU of a processing device 116. In some embodiments, one or more LEDs are arranged in a similar manner as a traffic light arrangement, for example, an LED that illuminates a red, yellow, or green color depending on the state of the cart 10 and a detection of an obstacle in front of the cart, for example, described in FIG. 5.

Referring to FIG. 3, a feature of the self-contained cart 10 is that in some embodiments, the processing device 116 can communicate directly with the sensors and drive the LED 112 internally to the cart 10 without the need for a centralized network 16 as shown in FIG. 3, which can reduce or eliminate a response time due to the elimination of latency that would occur if such data was exchanged via the network 16. However, in other embodiments, a store-based network 16 may be employed, which requires the network interface 132 on the cart 10, so that relevant shopping-related operations, such as personal scanning, pre-existing beacons, e.g., beacons 18 shown in FIG. 3, can be part of an operation including the cart 10.

The haptic feedback elements 129 include vibrating or other tactile-generating elements that generate haptic feedback used to establish whether the user has control over the cart 10 while it is moving. For example, haptic feedback generated at the haptic feedback devices 128 may cause the handle 106 to vibrate when the user 11 moves within a predetermined proximity of an obstacle in front of the shopping cart 10.

The pressure sensors 129 or the like that are constructed and arranged to detect a presence of a user's hand on the cart 10, for example, positioned at a location on the handle 106 where a user's hand may grasp the handle 106. Other sensors may equally apply for detecting whether a user is pushing the cart and/or authorizing the user. For example, a biometric sensor such as a fingerprint identification system on the handle 106 may establish whether a child is pushing the cart 10 or other holding onto the handle 106 of the cart 10 when it is moving. When a human hand is detected, visual, audio, and/or haptic feedback may be generated, for example, to provide alerts, alarms, instructions, and so on, for example, using the relevant output devices described herein.

In some embodiments, the cart 10 includes an electric charging unit 120 that is coupled to the frame 101, base 104, or handle 106 and that charges some or all of the electrical components of the cart 10. In some embodiments, a charging port or the like may be located on the handle 106 or other accessible location of the cart 10 to allow a user to plug in a smartphone or other electronic device for charging the device using the charging unit 120. The charging unit 120 has a power cord 121 or the like that plugs into an external voltage source such as an 110V or 220V wall socket.

The charging unit 120 can provide a received source of power to an electrical energy storage device such as a battery 118 or other suitable devices for storing electrical energy, for example, located at the frame 101, base 104, or handle 106. Voltage regulators, rectifiers, converters, capacitors, switches, or related elements may be part of or positioned between the charging unit 120 and the electrical storage device 118 for regulating or otherwise providing a sufficient electric charge to the electrical storage device 118. In some embodiments, the charging unit 120 provides a source of kinetic charging, so that charging occurs while the cart 100 is in motion. In some embodiments, the top of the cart (130) may include miniaturized solar panel technology such as solar cells as an auxiliary energy source, for example, when the cart is in a cart corral.

The cart 10 also includes a plurality of sensors, e.g., part of a sensor system 210 shown in FIG. 2, that are constructed and arranged detect and recognize an object along the path of the shopping cart 10, and to determine a type of detection that in turn establishes a type of alert or other feedback generated for the user's attention. In some embodiments, the sensors of the sensor system 210 include a combination of proximity and motion sensors, which may be located on both ends of the cart 10, for example, two sensors on each end or corner of the cart 10.

A first set of the sensors may include one or more proximity sensors 113 positioned on the cart 10 for detecting and recognizing obstacles in the path in front of and/or to the sides of the cart 10. The proximity sensors 113 are constructed and arranged to detect any object within a predetermined distance from the cart 10, for example, 1.5 m, such as other carts, moving objects, and so on. The proximity sensors 113 may include, but not be limited, to cameras, light detection and ranging (LIDAR), or the like for detecting features of the obstacles at risk of collision with the cart 10 if the cart 10 proceeds along a current path. In some embodiments, the obstacles are stationary such as walls, shelves, pylons, and so on. In other embodiments, the obstacles are moving, such as another cart, a child in an aisle, and so on. In other embodiments, a proximity sensor 113 recognizes the obstacle, for example, distinguishing a shopping cart from a wall. In other embodiments, a proximity sensor 113 receives a signal from an obstacle that can be used to determine a distance between the cart 10 and the obstacle. The data in this signal can be used to perform method steps described in FIG. 5.

A second set of the sensors may include one or more spill sensors 114 that detect liquid spills. The spill sensors 114 may be similar to the proximity sensors 113 in that the spill sensors 114 may include specific sensor devices that distinguish a hazardous spill such as an oil or bleach spill from an innocuous spill such as a water spill, or determines a distance from the spill, and so on. For example, a spill sensor 114 may include a reflection-humidity sensor for detecting liquid spills, but is not limited thereto. In addition to the first and second set of sensors 113, 114, the cart 10 may be constructed and arranged with other types of detection devices, for example, including but not limited to chemical, biological, thermal, radiation, humidity, and/or other sensors. In some embodiments, the sensors may detect erratic motion of the cart 10, for example, implying that the cart operator is impaired or is a child. When erratic motion is determined, for example, swerving and so on, the system may activate the autobrake. In other embodiments, a user is not operating the cart 10, for example, the cart 10 is stationary in a parking lot but unexpectedly moves due to wind, gravity, an automobile drives into it, and so on where the autobrake may be activated when the sensors detect such unexpected motion.

The sensors 113, 114 may be in communication with the computer processing device 116, feedback system 204, and/or controller 208 via a communication line such as a data cable. Alternatively, the communication can be wireless via the network interface 132.

The battery 118 of the charging unit 120 may be configured and arranged for daisy-chain charging, for example, to in turn charge other batteries or the like when the power cord 121 is in electrical contact with a power source, such as a wall socket. In other embodiments, the battery 118 is charged by the motion of the wheels 105, using a charging unit, generator, and related mechanical and electro-mechanical components. The cart 10 may include a feeder apparatus that controls a movement of the cart 10 with respect to other carts to be charged, for example, by automatically positing the cart 10 for electrical connectivity between connectors of the adjacent carts so that a neighboring cart can be charged by the cart 10 using the power source and/or battery 118 of the cart 10. The charging unit 120 may include a voltage, current, and/or power monitor which determines a current power level and a controller that can adjust a charging wattage or related power level in response to a user-defined or predetermined set of conditions, for example, increasing or decreasing a charging level of the battery 118 during certain times of the day.

In some embodiments, the charging unit 120 includes one or more solar panels coupled to various regions of the cart 10 to allow the battery 118 to be charged via solar power. In some embodiments, the charging unit 120 includes a wireless charging panel for charging the battery 118 via radiation exchanged between the panel and the battery 118. In other embodiments, the charging unit 120 includes a generator and other related elements for converting kinetic energy produced by the wheels 105 to electricity, which can be stored at the battery 118.

Although not shown, the cart 10 may include one or more peripheral or ancillary devices that may be used by a shopper when operating the cart 10. In some embodiments, the cart may include a weight scale, for example, positioned in the interior of the basket 102 which can output a weight value that is displayed on an electronic display on the cart, or output via a wireless connection to a mobile device of the contents in the basket 102. In other embodiments, the cart 10 may include a scanning device that allows store items to be autoscanned, for example, Digimarc™ technology, for identifying and processing information regarding items placed in the cart 10. An example application of this feature is that a shopping list can be automatically generated and stored by a computer processor, so that an aggregate of items acquired and placed in the cart 10 is provided to a point of sale system at a checkout counter.

FIG. 2 is a block diagram of a cart collision avoidance system 200, in accordance with some embodiments. Some or all of the cart collision avoidance system 200 may be part of the shopping cart 10 shown and described with reference to FIG. 1.

The cart collision avoidance system 200 comprises a proximity detection system 202, a feedback system 204, a braking system 206, and a controller 208. In some embodiments, some or all of the proximity detection system 202, feedback system 204, braking system 206, and controller 208 are part of the shopping cart 10 of FIG. 1. In some embodiments, the system 200 also includes the charging unit 210 shown and described with respect to FIG. 1. In other embodiments, some elements of the proximity detection system 202, feedback system 204, braking system 206, controller 208, and charging unit 210 are coupled to the shopping cart 10 while other elements are remote from the cart 10 and in electronic communication with those elements coupled to the cart 10. The special-purpose computer processor 116 of the proximity detection system 202 can facilitate and control such communications between the other electronic devices on the shopping cart 10. In some embodiments, the special-purpose computer processor 116, also referred to as a cart computer, includes a Raspberry PI device or the like for performing control-related operations of the cart 10. In some embodiments, the special-purpose computer processor 116 performs other functions such as processing system diagnostics that are stored in a memory device (not shown). The system diagnostics when executed can inform the user of problems with the cart 10, for example, provide on a display on the cart or the user's smartphone 12 (see FIG. 3) or other remote computing device, e.g., store computer 14, of a charging status, sensor status, maintenance update alert, and so on. In some embodiments, the computer processing device 116 includes a memory that stores planogram data for use in identifying the object or whether the object may cause a collision. For example, a time or date stamp of the cart's last known captured store layout may be compared and communicated with other carts 10, for example, when the carts 10 are stored together in a cart corral. A cart with an older layout in memory may receive a newer store layout from a different cart so that carts in use at a store are configured with the same store layout or other software that allows the cart 10 to operate.

The proximity detection system 202 is constructed and arranged to determine if an obstacle is detected by the proximity detection system 202 to be in front of the cart 10, and possibly identify the obstacle. The data from such determinations can be used to generate a course of action, for example, instruct an LED to illuminate a particular color, activate the braking system 206, send notifications to electronic displays either on the cart 10 or remove from the cart, and so on. The proximity detection system 202 may include cameras, light detection and ranging (LIDAR) and/or other sensor or detection technology for detecting and recognizing obstacles in the path along which the shopping cart 10 travels. For example, the proximity sensors 113 shown in FIG. 1 may include one or more cameras 42 positioned on the shopping cart 10 for detecting obstacles in the path along which the shopping cart 10 travels. The proximity sensors 113 may alternatively or additionally include a LIDAR device or related laser range finding system to provide collected inputs from object detection to a shopping cart computer 116 which may process an alarm signal used by the haptic devices 128 and/or speaker 124 to generate a notification, queues, direction instruction, alarm, and/or other information.

In some embodiments, sensor system 210 that includes a plurality of proximity sensors 113 described above, but also other sensor types such as motion sensors, spill sensors 114 shown in FIG. 1, and so on.

The proximity detection system 202 may also include a special-purpose computer processing device 116 and the network interface 132, which may be co-located under a common housing or may be remote from each other. In some embodiments, the computer processing device 116 communicates with the sensors 113 to reduce false alarms by re-baselining the sensors 113 each time a sensor is activated, Upon re-baselining, the system can identify if a new person detected by the sensor 113 has a small child, is a new customer, and so on. A beacon 18 (see FIG. 3) along a path of travel of the cart 10 may automatically turn the system off until a signal communication is reestablished and re-baselined.

In some embodiments, the computer processing device 116 is constructed and arranged to collect data from the sensors and in response to drive the LEDs 112 and/or other visual, audio, and/or sensory indicators of the feedback system 204. The computer processing device 116 can be configured to establish when the system trips, which in response can activate a feedback component such as an LED 112. For example, distance, speed, angular direction, and so on can be determined, then processed, for example, to establish that the cart 10 is moving toward an object at a particular speed, but that a wall determined to be 1 m may trip the system, but a cart moving at the same rate toward a wall 15 m away would not trip the system. In another example, the cart 10 to be determined to close in on another moving cart at a particular rate, e.g., 3 m/s at a 10 degree angle of incidence and 1.5 m away may not trip the system, but a cart moving at 3 m/s at a 40 degree angle of incidence and 1.5 m away may trip the system's alarm system due to the angular component and time to projected impact.

The computer processing device 116 can also communicate with the controller 208 to control the braking system 206, for example, to automatically lock the wheels using an autobrake mechanism 133 (see FIG. 3) when the sensors detect an obstacle, object, or event that is determined to be sufficiently close to the cart 10 to be a risk of an impending collision. In some embodiments, the controller 208 can control the movement of the cart, for example, causing the brakes to apply a sufficient force to the wheels 105 so that a user cannot push it forward at an excessive speed, for example, at a threshold greater than 5 mph.

As described above, the network interface 132 may include global positioning (GPS), infrared (RFID), and/or WiFi devices to determine a proximity of the cart 10 from an object, obstacle, or event of interest. Other network interface types may include a Geo Cloud or geolocated WiFi network interface, Bluetooth™, and/or other electronic communication devices that allow an exchange of electronic signals, data, and the like between the cart 10 and external electronic devices such as sensors 18 used for geofencing or other location features.

In some embodiments, as shown in FIG. 2, the feedback system 204 includes a combination of visual, audio, and/or tactile indicator elements that inform a cart user of a state of the cart 10 with respect to an obstacle-free path along with which the cart 10 is moving. For example, the feedback system 204 may include but not be limited to the light emitting elements 112, audio speaker 124, and haptic feedback devices 128 of the cart 10 shown in FIG. 1.

FIG. 4 is a block diagram illustrating the relationship between elements of the cart collision avoidance system when implemented in a shopping cart, in accordance with some embodiments.

The charging unit 120 may charge a battery 118, for example, using kinetic energy such as wheel motion. The battery 118 in turn is in communication with a DC module 123 or the like, which in turn can provide power to the computer processing device 116 and/or other electronic devices requiring DC power. The computer processing device 116 in turn communicates with the various hardware components of the shopping cart 10, such as light emitting devices 112, proximity sensors 113, spill sensors 114, a sensory module 128, speed controller 141, brake sensor 142, audible output 124, and so on. The network interface 132 may activate a geofence or other network 116, which may be used as part of an alerting process, for example, output alerts to a mobile device 12 within a store location.

FIGS. 5A- 5G collectively illustrate a flow diagram of a method of operation of a cart collision avoidance system, in accordance with some embodiments. In describing FIGS. 5A-5G, reference may be made to elements of FIGS. 1-4.

At block 404, the customer retrieves a shopping cart 10, for example, from a cart corral or other location at or near an entrance to the store.

At block 406, the customer's presence is sensed by the shopping cart 10, for example, when the customer places a hand on the handle 106 and a presence sensor 129 detects the customer. In some embodiments, when the customer's presence is detected, the braking system 206 receives a signal from the presence sensor 129 or an autobrake controller of the controller 208 (see FIG. 3) that instructs the braking system 206 to withdraw a force applied to one or more cart wheels to allow the wheels to rotate and for the cart 10 to be used by the customer. Other features such as sensor 129 may include the use of biometrics to identify the customer, synchronize electronically with a smartphone or other mobile device, and/or to program the cart to operate in unique ways depending on the customer's identification.

At block 408, the shopping cart 10 is detected by a store geofence, WiFi, or related network apparatus.

At decision diamond 410, a determination is made whether the cart collision system is enabled. For example, a remote software application executed on a mobile device may generate a command that is communicated to the system, or the on/off switch 122 may provide this determination. If a determination is made that the cart collision system is indeed not enabled, then the method proceeds to block 412, where the cart collision avoidance system 200 is inactivated, for example, controlled by the controller 208 so that one or more elements of the cart collision avoidance system 200, for example, shown in FIG. 2, remain inactivated even though the cart 10 entered the store geofence, WiFi network, or the like In doing so, no LEDs 112 are activated, i.e., illuminated a particular color. If a determination is made that the cart collision system 200 is enabled, then the method proceeds to block 416, where at least one LED 112 located on the car 10 is activated, for example, illuminating a green LED indicating that the cart 10 is operational and ready for use.

At decision diamond 418, a determination is made whether the cart 10 is moving, for example, by the customer or other user such as a store associate. If the cart 10 is not moving, then the method proceeds to block 420 where location data of the cart 10 is output via the network interface 132 to other carts configured with a cart collision avoidance system similar to the system 200 in the non-moving cart 10. This location data can be used to pre-emptively avoid the non-moving cart 10 inside the geofence 16. Also, at block 420, the non-moving cart 10 can activate an LED 112 to illuminate a particular color, display pattern, or other indicator that establishes a state of the cart 10, for example, illuminating a red color indicating that the cart 10 has been struck by another cart or other collision has occurred, or illuminating a green color indicating that the cart 10 is in an operational state, i.e., ready for movement.

If at decision diamond 418 a determination is made that the cart 10 is moving, then the method proceeds to decision diamond 422, where a determination is made whether the cart 10 is moving at a speed that is determined to be unsafe. Other decisions made be established, for example, whether a pressure sensor 129 detects a user's hand on the handle 106, where at block 423 a red LED 112 is generated or an autobraking feature is activated where the braking system 206 automatically locks one or more wheels of the wheel assembly 105. If at decision diamond 422 the computer processor determines that the cart 10 is moving at a speed that is at or less than a speed that is predetermined to be a safe speed, for example, less than 5 mph and a hand is detected on the handle 106 (see block 426), then the method proceeds to decision diamond 434, where a determination is made an obstacle is in front of the cart 10 or otherwise along a path of the cart 10, for example, within a first predetermined distance from the cart 10, for example, 5 feet.

If at decision diamond 434 a determination is made that an obstacle is not in front the cart 10, then the method proceeds to block 436, where at least one LED 112 is either activated, for example, illuminating a green LED indicating that the cart 10 is operational and ready for use, or remains at this state if the LED 112 is already illuminated, e.g., remains illuminated at green. If an obstacle is detected by the proximity detection system 202 to be in front of the cart 10, then the method proceeds from decision diamond 434 to decision diamond 444, where an obstacle type is determined. Obstacle types may include but not be limited to stationary non-moving objects (block 452), such as a wall, another cart (block 480), a spill (block 450) such as a hazardous material spill, e.g., oil or bleach spill, or moving object (block 456) such as a person or forklift in the path of the cart 10.

Returning to decision diamond 422, if the special purpose computer processing device 116 determines that the cart 10 is moving at a speed that is at unsafe speed, for example, greater than a predetermined safe speed, for example, 5 mph and optionally also a hand is detected on the handle 106 (see block 424), then the method proceeds to block 428 where an alert is generated for the user, such as an LED 112 illuminating a red color, a haptic element on the handle 106 that vibrates, a voice prompt output from the speaker 124 warning the user to slow down, or a combination thereof. Other alerts may include a data signal output from the special purpose computer processing device 116 to the user's smartphone or other mobile device in wireless or direct electronic communication with the device 116. The method then proceeds to decision diamond 430, where a determination is made whether the cart 10 has slowed down to be within an acceptable speed range. If yes, then at block 432, the LED 112 outputs a different source of light indicating the change of status, for example, changed to a green color indicating that the cart 10 is moving at a safe speed. This feedback loop may be formed between steps 422, 424, 428, 430, and 432 to constantly monitor the speed of the cart 10.

However, if at decision diamond 430 a determination is made that the cart 10 has not slowed down in response to block 428, then the method proceeds to block 440, where an electronic communication is automatically output from the cart 10 via a network output device 132 that includes a notification, alert, or the like to a mobile electronic device of a store associate or other resource who may take action against the user operator. At block 442, an action is taken against the user, such as a message automatically sent to the user's mobile device, or automatically generated from the audio device 124, or other form of communication. In some embodiments, a signal is generated and output from a store server or other computer to the cart 10, which in response automatically disables electronic operations, such as shopping list generation, use of the electronic devices on the cart 10, or activates the braking system 206 to automatically lock one or more wheels of the wheel assembly 105.

Returning to block 436, subsequent to activating an LED 112, the method proceeds to block 580 and decision diamond 418, where the system establishes that the cart 10 is moving unless the cart 10 is at a geofence (e.g., part of the network 16 of FIG. 3) or other detector of an exit from the store or the cart collision decision is disabled (block 582). In some embodiments, intervening steps 424, 428, 430, and/or 442 may be performed between decision diamond 418 and block 580.

Returning to decision diamond 444, if the identified obstacle is a non-moving object (block 452) such as a wall or the like, then the method proceeds to block 454, where the LED 112 is illuminated to indicate a yellow light or other alert indicating that the cart 10 is within a predetermined distance from the wall or other non-moving object, for example, 6 inches. The LED 112 may receive an electronic signal from the proximity detection system 202 which in turn receives data from the sensor system 210 to instruct which LED(s) 112 to be activated and/or to indicate that a yellow light is to be generated.

At decision diamond 460, a determination is made whether a collision has occurred between the cart 10 and the stationary object. The cart 10 may include collision detection devices or the like and/or rely on the proximity sensors 113 to establish whether a collision has occurred. If a collisions is determined, then at block 462 a red LED is illuminated. If a major collision is detected, for example, where the cart is damaged or its integrity has been compromised, then a different alert may be generated, for example, an electronic notification to a store employee and/or supervisor's mobile device. Along these lines, other features may address the severity of the collision and the magnitude of the collision, e.g., if the collision involves a person. Here, the cart can be moved by a user such that it could be removed from the area and not impede other shoppers from being able to continue to shop. Members of management may be notified to record the incident and provide necessary assistance for all involved.

Other alerts may equally apply such as a handle vibration, voice prompt to adjust the cart, and so on. At decision diamond 463, a determination is made after the collision whether the cart 10 has slowed down to be within an acceptable speed range within a predetermined period of time for example, 10 seconds. If yes, then at block 464, the LED 112 outputs a different source of light indicating the change of status, for example, changed to a yellow color indicating an alert, for example, that the cart 10 is within a threshold distance from a stationary object, where the method returns to decision diamond 460. If on the other hand at decision diamond 463 a determination is made that the cart operator has not improved the behavior of operating the cart 10 at a safe speed, then the method returns to block 462, where the red LED remains illuminated.

Returning to decision diamond 460, if the system determines that a collision has not occurred between the cart 10 and the stationary object, then the method proceeds to decision diamond 466, where a determination is made whether the stationary object is greater than a second predetermined distance from the cart 10 (different than first predetermined distance at decision diamond 434), for example, greater than 6 inches from the cart 10. If no, then the method proceeds to block 468 where the LED 112 is illuminated to indicate a yellow light or other alert indicating a state where the cart 10 is within a predetermined distance from the wall or other non-moving object for example, 6 inches or less. The method proceeds to block 470 where the cart 10 is in motion then to decision diamond 466. If at decision diamond 466 a determination is made that the stationary object is greater than the second predetermined distance from the cart, for example, greater than 6 inches, then the method proceeds to block 472, where the LED 112 is illuminated green or other indicator of an acceptable state of the cart 10.

Returning to decision diamond 444, if the identified obstacle is another cart (block 480), then then method further proceeds to decision diamond 482, where a determination is made whether the cart 10 is less than a predetermined distance, e.g., 3 feet, from the other cart. The determination may be made by the proximity detection system 202 and/or an electronic communication between the two carts, for example, using WiFi triangulation, a Bluetooth communication, and so on. If no, then the method proceeds to block 484, the LED 112 maintains a current color, for example, a green color. The method may then proceed to block 580, where the system establishes whether the cart 10 is moving.

If yes, then the method proceeds to block 486, where the LED 112 emits a yellow light or other different color indicating a change in state, for example, a state that alerts the cart user of an impending or possible collision. In addition or alternatively, a vibrating handle 106 may warn the cart user of an impending collision. At decision diamond 488, a determination is made whether the cart is at a shorter distance from the other cart than the distance determined at decision diamond 482, for example, 1 foot or less. If yes, then the method proceeds to block 490, where a red LED is illuminated, for example, similar to block 462. The method then proceeds to decision diamond 492, wherein a determination is made whether the user's behavior changes, for example, whether the cart 10 has slowed down to be within an acceptable speed. If no, then the method returns to block 490. If yes, then the method proceeds to block 494 where the LED 112 emits a yellow light or other indicator similar to block 486.

Returning to decision diamond 488, if a determination is made whether the cart is not at a shorter distance from the other cart, or a different distance such as 1 foot, than the distance determined at decision diamond 482, then the method proceeds to decision diamond 500, where a determination is made whether the cart 10 is at a distance greater than a predetermined distance, for example, similar to a threshold distance in decision diamond 482 such as 3 feet. If yes, then the method proceeds to block 502 where an LED 112 illuminates a green light. The method can then proceed to block 580, where the system establishes whether the cart 10 is moving. If no, then the method proceeds to block 504 where an LED 112 illuminates a yellow light. The method then proceeds to block 506 where a cart movement is made. Although blocks 502 and 504 describe a green and yellow light respectively, other colors indicating relevant states may equally apply.

Returning to block 456, the obstacle is determined to be a moving object, such as a child, forklift, and so on. At block 458, the proximity detection system 202 determines that the cart is anticipated to collide with the moving object, for example, by the processor determining from the cart velocity, i.e., using sensor data that measures the wheel movement and/or other determinants of cart velocity along with the motion sensors determining the moving object's velocity, direction of motion, and so on.

At decision diamond 530 where a determination is made whether the cart 10 is less than a predetermined distance, e.g., 3 feet, from the moving object. If no, then the method proceeds to block 532 where the LED 112 maintains a current color, for example, a green color. The method may then proceed to block 580, where the system establishes whether the cart 10 is moving.

If yes, then the method proceeds to block 534 where an LED 112 illuminates a yellow light or other indicator indicating a change in state, for example, a state that alerts the cart user of an impending or possible collision. The method then proceeds to decision diamond 536 where a determination is made whether the cart is at a shorter distance from the moving object than the distance determined at decision diamond 530, for example, 1 foot or less. If yes, then the method proceeds to block 538, where a red LED is illuminated, for example, similar to blocks 462 and 490. The method then proceeds to decision diamond 540, wherein a determination is made whether the user's behavior changes, for example, whether the cart 10 has slowed down to be within an acceptable speed. If no, then the method returns to block 538. If yes, then the method proceeds to block 542 where the LED 112 emits a yellow light or other indicator similar to blocks 486 and 494.

Returning to decision diamond 536, if a determination is made whether the cart is not at a shorter distance from the moving object or a different distance such as 1 foot, than the distance determined at decision diamond 530, then the method proceeds to decision diamond 544, where a determination is made whether the cart 10 is at a distance greater than a predetermined distance, for example, similar to a threshold distance in decision diamond 530 such as 3 feet. If yes, then the method proceeds to block 546 where an LED 112 illuminates a green light. The method can then proceed to block 580, where the system establishes whether the cart 10 is moving. If no, then the method proceeds to block 548 where an LED 112 illuminates a yellow light. The method then proceeds to block 550 where a cart movement is made. Although blocks 546 and 548 describe a green and yellow light respectively, other colors indicating relevant states may equally apply.

Returning to block 450, the obstacle is determined to be a spill. At block 510, the proximity detection system 202 determines that the cart is anticipated to enter the spill, by the processor determining from the cart velocity, i.e., using sensor data that measures the wheel movement and/or other determinants of cart velocity.

At decision diamond 512 where a determination is made whether the cart 10 is less than a predetermined distance, e.g., 3 feet, from the spill. If no, then the method proceeds to block 514 where the LED 112 maintains a current color, for example, a green color. The method may then proceed to block 580, where the system establishes whether the cart 10 is moving.

If yes, then the method proceeds to block 516 where an LED 112 illuminates a yellow light or other indicator indicating a change in state, for example, a state that alerts the cart user of an impending or possible collision. The method then proceeds to decision diamond 518 where a determination is made whether the cart is at a shorter distance from the spill than the distance determined at decision diamond 512, for example, 1 foot or less. If yes, then the method proceeds to block 520, where a red LED is illuminated, for example, similar to blocks 462 and 490. The method then proceeds to decision diamond 521, wherein a determination is made whether the user's behavior changes, for example, whether the cart 10 has slowed down to be within an acceptable speed. If no, then the method returns to block 520. If yes, then the method proceeds to block 522 where the LED 112 emits a yellow light or other indicator similar to blocks 486 and 494.

Returning to decision diamond 518, if a determination is made whether the cart is not at a shorter distance from the spill or a different distance such as 1 foot, than the distance determined at decision diamond 512, then the method proceeds to decision diamond 524, where a determination is made whether the cart 10 is at a distance greater than a predetermined distance, for example, similar to a threshold distance in decision diamond 512 such as 3 feet. If yes, then the method proceeds to block 525 where an LED 112 illuminates a green light. The method can then proceed to block 580, where the system establishes whether the cart 10 is moving. If no, then the method proceeds to block 528 where an LED 112 illuminates a yellow light. The method then proceeds to block 526 where a cart movement is made. Although blocks 525 and 528 describe a green and yellow light respectively, other colors or audio, visual, and/or tactile indicators corresponding to relevant states may equally apply.

Special-purpose computers may be included in one or more systems and methods of FIGS. 1-5. Such computers may generally comprise a processor, and an input device, output device, and memory each coupled to the processor via a bus. The processor may perform computations and control the functions of the computer, including executing instructions included in the computer code for the tools and programs capable of implementing a method for executing some or all present inventive concepts in the manner prescribed by the embodiments of FIGS. 1-5, wherein the instructions of the computer code may be executed by the processor via the memory device. The computer code may include software or program instructions that may implement one or more algorithms for implementing the methods for cart collision avoidance, as described in detail above. The processor executes the computer code. The processor may include a single processing unit, or may be distributed across one or more processing units in one or more locations (e.g., on a client and server).

The memory device may include input data. The input data includes any inputs required by the computer code. The output device displays output from the computer code. Either or both memory devices may be used as a computer usable storage medium (or program storage device) having a computer readable program embodied therein and/or having other data stored therein, wherein the computer readable program comprises the computer code. Generally, a computer program product (or, alternatively, an article of manufacture) of the computer system may comprise said computer usable storage medium (or said program storage device).

Memory devices include any known computer readable storage medium, including those described in detail below. In one embodiment, cache memory elements of memory devices may provide temporary storage of at least some program code (e.g., computer code) in order to reduce the number of times code must be retrieved from bulk storage while instructions of the computer code are executed. Moreover, similar to processor, memory devices may reside at a single physical location, including one or more types of data storage, or be distributed across a plurality of physical systems in various forms. Further, memory devices can include data distributed across, for example, a local area network (LAN) or a wide area network (WAN). Further, memory devices may include an operating system (not shown) and may include other systems not shown.

In some embodiments, the computer system may further be coupled to an Input/output (I/O) interface and a computer data storage unit. An I/O interface may include any system for exchanging information to or from an input device or output device. The input device may be, inter alia, a keyboard, a mouse, etc. or in some embodiments the touchscreen of a device, a sensor, a mobile device, and the like. The output device may be, inter alia, a printer, a plotter, a display device (such as a computer screen), a magnetic tape, a removable hard disk, a floppy disk, etc. The memory devices may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer, and may include any type of transmission link, including electrical, optical, wireless, etc.

An I/O interface may allow computer system to store information (e.g., data or program instructions such as program code) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to cart collision avoidance systems and methods. Thus, an embodiment of the present invention discloses a process for supporting computer infrastructure, where the process includes providing at least one support service for at least one of integrating, hosting, maintaining and deploying computer-readable code (e.g., program code) in a computer system (e.g., computer) including one or more processor(s), wherein the processor(s) carry out instructions contained in the computer code causing the computer system to allow a smart cart to operate accordance with embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for avoiding collisions using a smart cart. Thus, the present invention discloses a process for supporting, deploying and/or integrating computer infrastructure, integrating, hosting, maintaining, and deploying computer-readable code into the computer system, wherein the code in combination with the computer system is capable of performing a method for avoiding collisions using a smart cart.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A shopping cart that avoids collisions during movement, comprising:
a proximity detection system comprising one or more sensors that detect and recognize an object along the path of the shopping cart;
a controller that determines from data collected by the one or more sensors whether a collision between the shopping cart and the object is possible;
a feedback system that provides one or more of audible, visual, or tactile feedback to a user of the shopping cart when the controller determines that the collision is possible; and
a braking system that automatically stops the shopping cart from continued motion when the controller determines that the collision is possible, wherein at least one of the feedback system and the braking system is activated in response to the controller determining that the shopping cart is a predetermined distance from the object.

2. The shopping cart of claim 1, wherein the detected object is another shopping cart with a sensor that communicates with the one or more sensors of the movement of the shopping cart.

3. The shopping cart of claim 1, wherein the detected object is a liquid spill, and wherein at least one of the sensors includes a reflection-humidity sensor for detecting the liquid spill.

4. The shopping cart of claim 1, wherein the path of the shopping cart includes a corner, and wherein the one or more sensors detect the object around the corner before the shopping cart reaches the corner during its movement.

5. The shopping cart of claim 1, further comprising a generator and a battery that provides power to the sensors and the feedback system.

6. The shopping cart of claim 1, wherein the braking system automatically prevents the shopping cart from motion when the shopping cart is not in use.

7. The shopping cart of claim 1, wherein the feedback system identifies the object before providing feedback or ordering the brake system to automatically activate.

8. The shopping cart of claim 1, wherein the shopping cart further includes a computer memory that stores planogram data for use in identifying the object or whether the object may cause a collision.

9. The shopping cart of claim 1, wherein the feedback system includes a plurality of light emitting diodes (LED) constructed and arranged to emit a plurality of different colors depending on a determined distance between the shopping cart and the object or depending on a state of the shopping cart.

10. A cart collision avoidance system, comprising:
a proximity detection system that detect s an object along the path of a shopping cart;
a controller that determines from data collected by the proximity detection system whether a collision between the shopping cart and the object is possible;
a feedback system that that notifies a user of the shopping cart in response to the proximity detection system detecting the object and provides one or more of audible, visual, or tactile feedback to a user of the shopping cart when the controller determines that the collision is possible; and
a braking system that automatically stops the shopping cart from continued motion when the controller determines that the collision is possible, wherein at least one of the feedback system and the braking system is activated in response to the controller determining that the shopping cart is a predetermined distance from the object.

11. The cart collision avoidance system of claim 10, further comprising a charging unit and a battery that provide power to the feedback system, the controller, and the proximity detection system.

12. The cart collision avoidance system of claim 10, wherein the detected object is another shopping cart.

13. The cart collision avoidance system of claim 10, wherein the detected object is a liquid spill, and wherein the proximity detection system includes a reflection-humidity sensor for detecting the liquid spill.

14. The cart collision avoidance system of claim 10, wherein the path of the shopping cart includes a corner, and wherein the proximity detection system detect the object around the corner before the shopping cart reaches the corner during its movement.

15. The cart collision avoidance system of claim 10, further comprising sensors for determining whether a force is applied to the cart, and wherein the braking system automatically prevents the shopping cart from motion when a determination is made that a force is not applied to the cart.

16. The cart collision avoidance system of claim 10, wherein the feedback system identifies the object before providing feedback or ordering the brake system to automatically activate.

17. The cart collision avoidance system of claim 10, wherein the shopping cart further includes a computer memory that stores planogram data for use in identifying the object or whether the object may cause a collision.

18. The cart collision avoidance system of claim 10, wherein the feedback system includes a plurality of light emitting diodes (LED) constructed and arranged to emit a plurality of different colors depending on a determined distance between the shopping cart and the object or depending on a state of the shopping cart.
